(19) United States
(12) Patent Application Publication
(10) Pub. No.: US 2026/0010464 A1
(43) Pub. Date: Jan. 8, 2026

(54) Systems and Methods for Automated Software Testing and Test Data Set Generation Using Workflow Path Monitoring and Modeling

(71) Applicant: Xactware Solutions, Inc., Lehi, UT (US)

(72) Inventor: Aaron C. Brunko, Lindon, UT (US)

(73) Assignee: Xactware Solutions, Inc., Lehi, UT (US)

(21) Appl. No.: 19/257,843

(22) Filed: Jul. 2, 2025

Related U.S. Application Data
(60) Provisional application No. 63/666,901, filed on Jul. 2, 2024.

(51) Int. Cl. G06F 11/3668; G06Q 40/08

(52) U.S. Cl. CPC G06F 11/3684; G06Q 40/08

(57) ABSTRACT

Systems and methods for automated software testing and test data set generation using workflow path monitoring and modeling are provided. The system includes a workflow path monitoring processor that executes a workflow monitoring software module, an artificial intelligence/machine learning (“AI/ML”) software module, and a test script generation software module. The workflow monitoring software module monitors one or more workflow paths taken by a user using one or more software applications or platforms. The AI/ML module processes the one or more workflow paths monitored by the workflow monitoring software module and develops a workflow model for the software application or platform. The test script generation software module automatically generates one or more test scripts and/or test data sets based on the one or more monitored workflow.

### RELATED APPLICATIONS

This application claims priority to U.S. Provisional Application Ser. No. 63/666,901 filed on Jul. 2, 2024, the entire disclosure of which is hereby expressly incorporated by reference.

### BACKGROUND

### Technical Field

The present disclosure relates generally to the field of software testing and validation. More specifically, the present disclosure relates to systems and methods for automated software testing and test data set generation using workflow path monitoring and modeling.

### RELATED ART

In the field of software development, the ability to develop and test software in real-world situations is paramount. That is, in order for reliable software to be developed, it is critical to be able to test how a particular piece of software functions before it is deployed (e.g., before deployment in a production environment) in order to adequately address any errors, bugs, or other adverse conditions that could hinder successful deployment of the software. Such testing is important not only for standalone software (e.g., a single instance of software executing on a computer system), but also for web-based and cloud-based software systems and platforms.

When utilizing software applications/platforms, users often engage in various sequences of operations or “workflows” in order to achieve a desired output. Monitoring of user actions (“paths”) taken during such workflows can yield important information that can be harnessed to improve the future functionality of the software application or platform. Additionally, artificial intelligence and machine learning can be applied to monitored workflow paths in order to adjust or “tune” software applications and platforms so that they may operate in the best possible way for a user or groups of users. Even further, generative artificial intelligence technology can be utilized to automatically generate test code and/or test data sets from monitored workflow paths, and such test code and/or data sets can be utilized to improve the functionality of software systems/platforms.

Accordingly, what would be desirable, but has not yet been provided, are systems and methods for automated software testing and test data set generation using workflow path monitoring and modeling, which address the foregoing and other needs.

### SUMMARY

The present disclosure relates to systems and methods for automated software testing and test data set generation using workflow path monitoring and modeling. The system includes a workflow path monitoring processor that executes a workflow monitoring software module, an artificial intelligence/machine learning (“AI/ML”) software module, and a test script generation software module. The workflow monitoring software module monitors one or more workflow paths taken by a user using one or more software applications or platforms. The AI/ML module processes the one or more workflow paths monitored by the workflow monitoring software module and develops a workflow model for the software application or platform. The test script generation software module automatically generates one or more test scripts and/or test data sets based on the one or more monitored workflow paths which can be utilized to test and/or update the software application or platform prior to release of the software application or platform in a production environment.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure; and

FIGS. 2-3 are flowcharts illustrating processing steps carried out by the system of the present disclosure.

### DETAILED DESCRIPTION

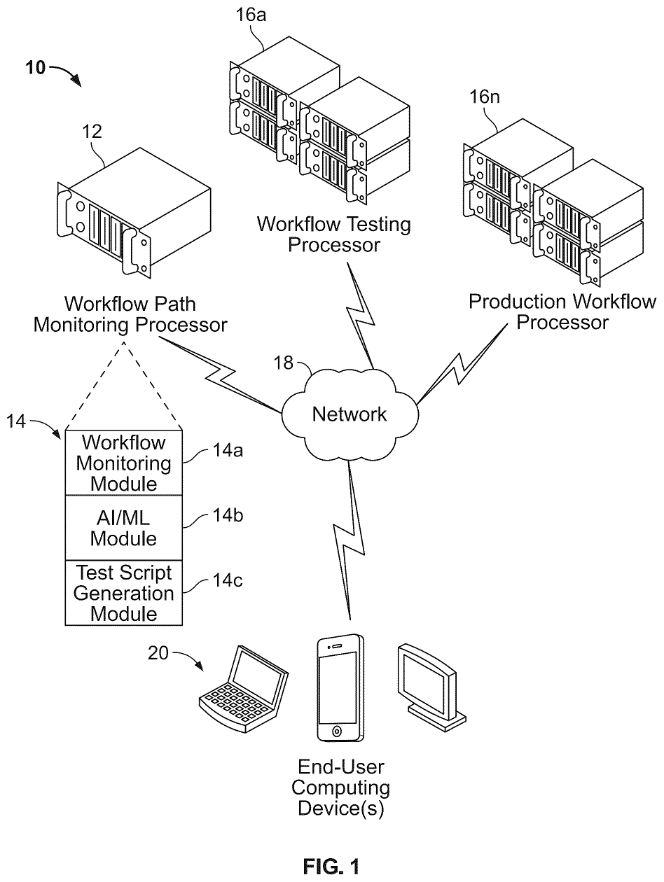

The present disclosure relates to systems and methods for automated software testing and test data set generation using workflow path monitoring and modeling, as discussed in detail below in connection with FIGS. 1-3.

FIG. 1 is a diagram illustrating the system of the present disclosure, indicated generally at 10. The system 10 includes a workflow path monitoring processor 12 which executes a plurality of software modules 14 including, but not limited to, a workflow monitoring module 14a, an artificial intelligence/machine learning (“AI/ML”) module 14b, and a test script generation module 14c, in order to provide the functions and features described herein. More specifically, the workflow monitoring module 14a monitors one or more workflow paths (e.g., one or more series of operations undertaken by the user when utilizing a software application) taken by a user (e.g., one or more users of the end-user computing devices 20 discussed below) using one or more software applications or platforms. The AI/ML module 14b processes the one or more workflow paths monitored by the workflow monitoring module 14a and develops a workflow model for the software application or platform. The test script generation module 14c automatically generates one or more test scripts and/or test data sets based on the one or more monitored workflow paths, which can be utilized to test and/or update the software application or platform prior to release of the software application or platform in a production environment.

The processor 12 can communicate with one or more additional computing devices 16a-16n which could include, but are not limited to, a workflow testing processor 16a and a production workflow processor 16n. Additionally, the processor 12 can communicate with one or more end-user computing devices 20. Communication between the processor 12, the processors 16a-16n, and the devices 20 could be by way of a network 18, which could include, but is not limited to, the Internet, a local area network (LAN), a wide area network (WAN), a cellular data network, a wireless network, or any other suitable type of communications network. The processors 12 and 16a-16n could be any suitable computer systems and associated processor(s) including, but not limited to, servers, desktop computers, personal computers, laptop computers, cloud computing platforms, etc. The end-user computing device(s) 20 could include, but are not limited to, personal computers, servers, desktop computers, laptop computers, mobile telephones, smart phones, or any other suitable computing devices. Additionally, the software modules 14 could be programmed in any suitable high- or low-level programming language, including, but not limited to, Java, C, C++, C#, Python, Go, or any other suitable programming language, and could be stored as computer-readable instructions stored in one or more non-transitory, computer-readable media in communication with and/or forming part of the processor 12, including, but not limited to, random-access memory, read-only memory, flash memory, disk memory, or any other suitable memory. Still further, the processor 12 and modules 14 could be embodied as a custom-programmed hardware device, such as, but not limited to, an application-specific integrated circuit (ASIC), field-programmable gate array (FPGA), or any other suitable device.

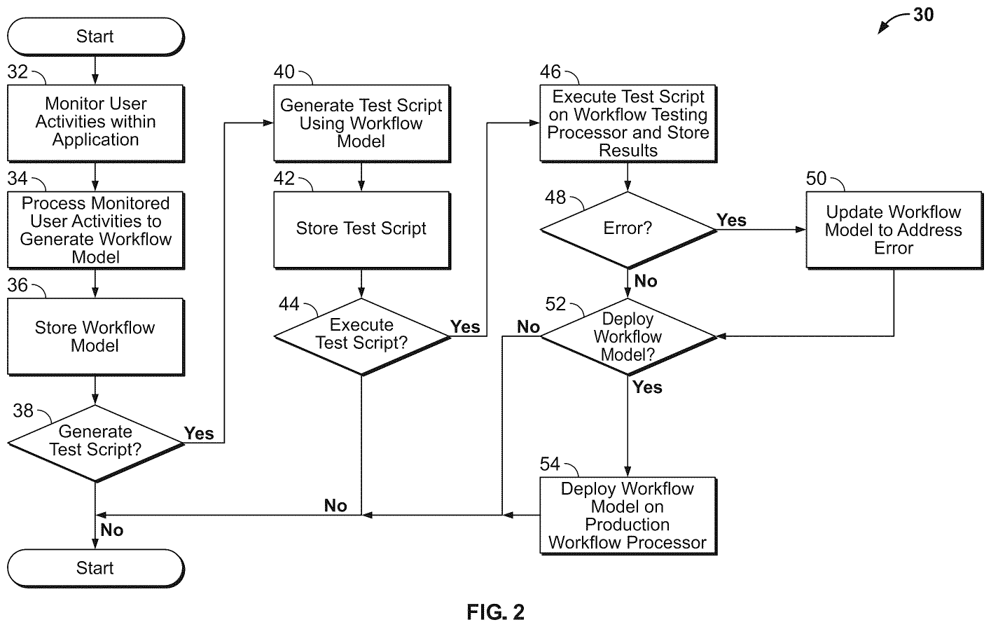

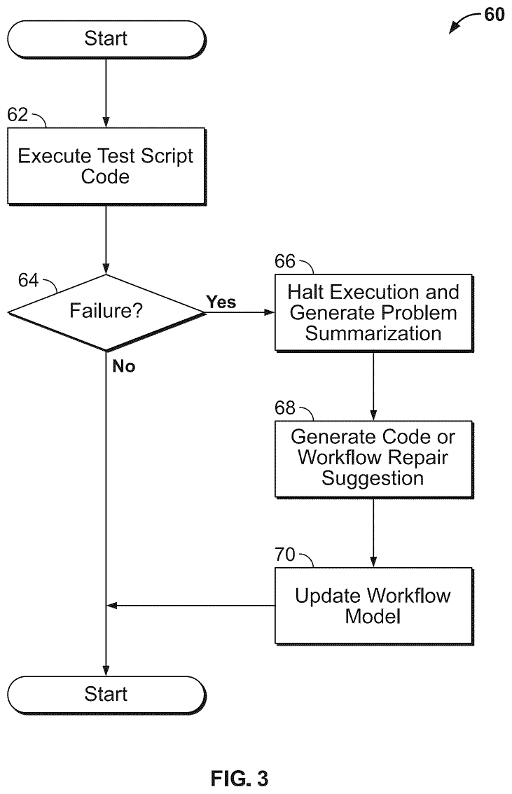

FIGS. 2-3 are flowcharts illustrating processing steps carried out by the system of the present disclosure. The steps discussed in connection with FIGS. 2-3 could be carried out by one or more of the software modules 14 of FIG. 1.

Referring to FIG. 2, in step 32, the module 14a monitors for one or more user activities occurring within a software application. For example, if the user of one or more of the computing devices 20 is utilizing an insurance claims processing software application such as the XACTIMATE claims processing software application sold by Xactware Solutions, Inc., the module 14a remotely monitors actions being taken by the user when utilizing the software application to process an insurance claim. Then, in step 34, the module 14a processes the monitored user activities in order to generate a workflow model. The workflow model is a representation of a typical workflow (series of steps) taken by the user when utilizing the software application. In step 36, the module 14a stores the workflow model (e.g., in memory or in a database forming part of, or in communication with, the processor 12). In step 38, a determination is made as to whether to generate a test script associated with the workflow model. If so, steps 40 and 42 occur, wherein the test script is generated by the module 14c and stored. Such a test script represents a series of computer-readable software instructions that can be used for future testing and adjustment of the software application being utilized by the user, and the instructions of the test script are based on the user's monitored actions as reflected in the workflow model. For example, if the workflow model indicates that the user frequently utilizes a specific sequence of functional features of the software application, the test script could include instructions which operate the software application to simulate the specific sequence, and/or it could include additional instructions added (or existing instructions modified) in a manner that optimizes future operation of the software application and/or “stress-tests” the software application so that refinements and/or corrections to the software can be made by one or more software engineers responsible for developing and/or maintaining the software code base associated with the software application.

It is noted that the module 14b could also operate in conjunction with the module 14a to assist with generation of the workflow model, utilizing one or more artificial intelligence or machine learning applications/models. For example, the module 14b could apply one or more generative AI models to the workflow model in order to suggest and/or incorporate additional workflow steps and/or to eliminate unnecessary workflow steps in order to generate an optimized test script for future use by the system. The input provided by the generative AI models could be incorporated into the workflow model and utilized in generating the test script.

In step 44, a determination is made as to whether to execute the test script. If so, step 46 occurs, wherein the test script is executed by the on the workflow testing processor 16a. Advantageously, the workflow testing processor 16a is a standalone computing environment in which the test script (and associated software application) can be executed, so that a production version of the software application is not disturbed and any errors are confined to the testing processor 16a. In step 48, a determination is made as to whether one or more errors occurred during execution of the test script. If so, step 50 occurs, wherein the workflow model can be updated to address the error(s) and so that future versions of the test script (generated from the updated workflow model) do not experience the error(s) during execution. In step 52, a determination is made as to whether to deploy the workflow model in a production environment. If so, step 54 occurs, wherein the workflow model is deployed on the production workflow processor 16n. At that point, the workflow model and its associated features are available for future usage in the software application utilized by the users.

FIG. 3 illustrates steps 60 performed by the test script generation module 14c in connection with execution of a test script. In step 62, the module 14c executes test script code on the workflow testing processor 16a. In step 64, a determination is made as to whether an error occurs during execution of the test script code. If so, step 66 occurs, wherein the module 14c halts execution of the test script code and generates a summary of the problem/error. In step 68, the module 14c could optionally generate code and/or suggest repairs or edits to the workflow model in order to address the problem/error. Then, in step 70, the module 14c updates the workflow model so that the repairs/edits are incorporated into the model.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A system for automated software testing and test data set generation, comprising:
a workflow path monitoring processor that executes (i) a workflow monitoring software module; (ii) an artificial intelligence/machine learning (AI/ML) software module; and (iii) a test script generation software module;
wherein the workflow monitoring software module monitors one or more workflow paths taken by a user using one or more software applications or platforms;
wherein the AI/ML software module processes the one or more workflow paths monitored by the workflow monitoring software module and develops a workflow model for the software application or platform; and
wherein the test script generation software module automatically generates one or more test scripts or test data sets based on the one or more monitored workflow paths.

2. The system of claim 1, wherein the one or more test scripts or test data sets can be utilized to test or update the software application or platform prior to release of the software application or platform in a production environment.

3. The system of claim 1, wherein the software application or platform comprises an insurance claims processing software application.

4. The system of claim 3, workflow monitoring software module monitors actions taken by a user when utilizing the insurance claims processing software application.

5. The system of claim 1, wherein the workflow model represents a series of steps taken by a user when utilizing the software application or platform.

6. The system of claim 1, wherein the workflow model indicates whether a user utilizes a specific sequence of functional features of the software application or platform.

7. The system of claim 6, wherein the one or more test scripts includes instructions which operate the software application or platform to simulate the specific sequence.

8. The system of claim 7, wherein the one or more test scripts includes additional instructions for optimizing future operation of the software application or platform or for stress testing the software application or platform.

9. The system of claim 1, wherein the AI/ML software module suggests processes the workflow model to suggest or incorporate additional workflow steps or eliminate unnecessary workflow steps in order to optimize the test script.

10. The system of claim 1, further comprising a workflow testing processor in communication with the workflow path monitoring processor, the workflow testing processor executing the one or more test scripts.

11. The system of claim 10, wherein the system updates the workflow model to address one or more errors occurring during execution of the one or more test scripts by the workflow testing processor.

12. A method for automated software testing and test data set generation, comprising:
monitoring by a workflow monitoring software module executed by a workflow path monitoring processor one or more workflow paths taken by a user using one or more software applications or platforms;
processing by an artificial intelligence/machine learning (AI/ML) software module executed by the workflow path monitoring processor the one or more workflow paths monitored by the workflow monitoring software module and developing a workflow model for the software application or platform; and
automatically generating by a test script generation software module one or more test scripts or test data sets based on the one or more monitored workflow paths.

13. The method of claim 12, further comprising utilizing the one or more test scripts or test data sets to test or update the software application or platform prior to release of the software application or platform in a production environment.

14. The method of claim 12, wherein the software application or platform comprises an insurance claims processing software application.

15. The method of claim 14, further comprising monitoring by the workflow monitoring software module actions taken by a user when utilizing the insurance claims processing software application.

16. The method of claim 12, wherein the workflow model represents a series of steps taken by a user when utilizing the software application or platform.

17. The method of claim 12, wherein the workflow model indicates whether a user utilizes a specific sequence of functional features of the software application or platform.

18. The method of claim 17, wherein the one or more test scripts includes instructions which operate the software application or platform to simulate the specific sequence.

19. The method of claim 17, wherein the one or more test scripts includes additional instructions for optimizing future operation of the software application or platform or for stress testing the software application or platform.

20. The method of claim 12, further comprising processing by the AI/ML software module the workflow model to suggest or incorporate additional workflow steps or eliminate unnecessary workflow steps in order to optimize the test script.

21. The method of claim 12, further comprising executing the one or more test scripts by a workflow testing processor in communication with the workflow path monitoring processor.

22. The method of claim 21, further comprising updating the workflow model to address one or more errors occurring during execution of the one or more test scripts by the workflow testing processor.
